(19) United States
(12) Patent Application Publication
(10) Pub. No.: US 2015/0324185 A1
(43) Pub. Date: Nov. 12, 2015

(54) METHOD FOR RECONFIGURING COMPONENTS, AND COMPONENT

(71) Applicant: ZUMTOBEL LIGHTING GMBH, Dombim (AT)

(72) Inventor: Michael BOEHNEL, Dornbirn (AT)

(21) Appl. No.: 14/396,783

(22) PCT Filed: Apr. 24, 2013
(86) PCT No.: PCT/EP2013/058505

§ 371 Date: Oct. 24, 2014

(30) Foreign Application Priority Data
Apr. 27, 2012 (DE) 10 2012 207 023.0

(51) Int. Cl. G06F 9/445; H05B 37/03; H05B 37/02

(52) U.S. Cl. CPC G06F 8/65; H05B 37/0209; H05B 37/03

(57) ABSTRACT

A Method for reconfiguring components arranged in a lighting system, in which, when reconfiguring a component, at least part of the software or data stored in the component is updated and/or additional software or data is/are stored in the component, wherein the reconfiguration is carried out during ongoing operation of the component, and a corresponding component with a management unit for reconfiguration.

The present invention relates to a method for reconfiguring components arranged in a lighting system, wherein, when reconfiguring a component, at least part of the software or data stored in the component is updated and/or additional software or data is/are stored in the component, and to a corresponding component.

Lighting systems often have a multiplicity of components which perform a wide variety of tasks inside the lighting system. For example, lamp operating devices which control a corresponding lamp and, at the same time, can communicate with a control centre of a lighting system via a bus are used as components in lighting systems. However, luminaires which have both luminous means and corresponding control and communication means could also likewise be used as components in the lighting systems. Furthermore, however, components which are provided for the purpose of controlling darkening units, for example, are also conceivable, as are controllers which may be provided for the purpose of controlling a plurality of luminaires.

In principle, the present invention relates to any component of a lighting system which stores software or data, which is used to control the component or devices connected to the component and in the process makes it possible to update and therefore renew or change the software or data and/or store additional software or data in the component. For this purpose, a component often has a computing unit or CPU with a corresponding program and data memory.

In the case of such components, in order to update the software or data for example, provision has hitherto been made for the component to be switched off or deactivated and for the software or data to then be accordingly updated. The component is then switched on again or activated only after the updating operation. Such an update may be required, for example, when faults occur in the software or data after the component has been started up or when the functionality of the component is intended to be changed or updated. Even when extending the range of functions of the component, the component has hitherto been deactivated or switched off in order to then store or install additional software or data in the component and accordingly extend the range of functions thereby.

During such reconfiguration of such components arranged in a lighting system, it has accordingly been hitherto necessary or conventional to switch off or deactivate the component, which is not always desired, however, in corresponding luminaires, for example.

Therefore, the present invention is based on the object of developing a reconfiguration method and a corresponding component, in which the previously explained problem of switching off or deactivating the component no longer exists.

The object is achieved by means of a method according to claim 1 and by means of a component according to claim 12. The dependent claims relate to the advantageous developments of the invention.

The invention proposes a method for reconfiguring components arranged in a lighting system, wherein, when reconfiguring a component, at least part of the software or data stored in the component is updated and/or additional software or data is/are stored in the component. In this case, the reconfiguration is carried out during ongoing operation of the component.

In this case, provision can be advantageously made for that part of the software or data which is not being used by the component at the time of the reconfiguration to be updated, that is to say the software or data is/are only partially updated.

As a result, there is no longer the problem of the component having to be switched off or deactivated for the purpose of reconfiguration, as a result of which the reconfiguration can no longer be perceived to be disruptive by a consumer or user.

For example, a luminaire or a lamp operating device could be operated in the dimming mode, while that part of the software which relates to diagnosis functions is simultaneously updated or changed or renewed.

In this case, provision may be made for the component to have only basic operating functions before a corresponding reconfiguration is carried out. Additional software or data, which expand(s) the component with additional functions, is/are then stored in the component as a result of the reconfiguration.

This procedure is appropriate, for example, when the intention is to produce a multiplicity of identical components which all have the same basic functions, but then additional functions are desired in individual components at a subsequent time, for example a long time after the components have been installed. In this case, it is then possible to expand the corresponding components with additional functions without having to disrupt the ongoing operation of the components.

Furthermore, provision may be advantageously made for at least part of the software or data to be parameters which are used to control the component or devices connected to the component, in which case they may be dimming curves, for example. In this case, when updating the parameters, provision may then be made for the component to still use the old parameters while new parameters are being transmitted to the component and to use the new parameters after transmission has been concluded, in which case the old parameters can then also be deleted after transmission has been concluded.

When storing additional new parameters, provision may be made for the component to then use the additional parameters after the transmission of the additional parameters has been concluded.

Provision may likewise be made for at least part of the software or data to be fault diagnosis functions which diagnose and evaluate faults in the component or in devices connected to the component. In this case, the fault diagnosis functions can be updated and/or additional fault diagnosis functions can be stored when a fault occurs.

Therefore, when a particular fault occurs, it is possible to transmit the fault diagnosis function optimal for this fault to the component, as a result of which this fault can be better diagnosed and evaluated. At the same time, it is also possible to accordingly diagnose and evaluate new faults by means of new fault diagnosis functions. In this case, it is advantageous, in particular, that the reconfiguration is carried out during ongoing operation of the component since temporary switching-off or deactivation of the component could possibly result in the loss of the subsequently required information relating to the fault since corresponding data would possibly be deleted by a switching-off or deactivation process.

Provision may also be preferably made for at least part of the software or data to be functions which make it possible to transfer calculation tasks, which should be carried out by one component during operation, to another component of the lighting system.

As a result, it is possible, for example, for one component to assist an adjacent component during corresponding intensive calculation tasks, which may be useful, for example, when using different generations of components since they may partially considerably differ in terms of their available computing power. In older components in particular, the situation may occur here, inter alia, in which newer functions with accordingly computation-intensive tasks cannot be carried out or implemented on account of the insufficient computing power. It is likewise also possible to optimize the energy efficiency, the computing time or else the resources of the components or of the lighting system by transferring computation tasks.

The previously described transfer or division of computation tasks between a plurality of components of a lighting system can also be carried out independently of the reconfiguration of the components. Accordingly, claim 14 also additionally proposes a method for dividing computation tasks between a plurality of components of a lighting system, in which the components have functions which make it possible to transfer calculation tasks, which should be carried out by one component during operation, to another component of the lighting system.

The invention also proposes a component of a lighting system, which component has a management unit which makes it possible to update at least part of the software or data stored in the component and/or to store additional software or data in the component during ongoing operation of the component.

In this case, the configuration and state of the component and the software or data stored in the component are preferably known to the management unit.

In the case of the components mentioned above, at least some may be lamp operating devices or else controllers, in which case the controllers are provided for the purpose of controlling a plurality of luminaires or lamp operating devices.

The invention shall be explained in more detail below using exemplary embodiments and the accompanying drawing, in which:

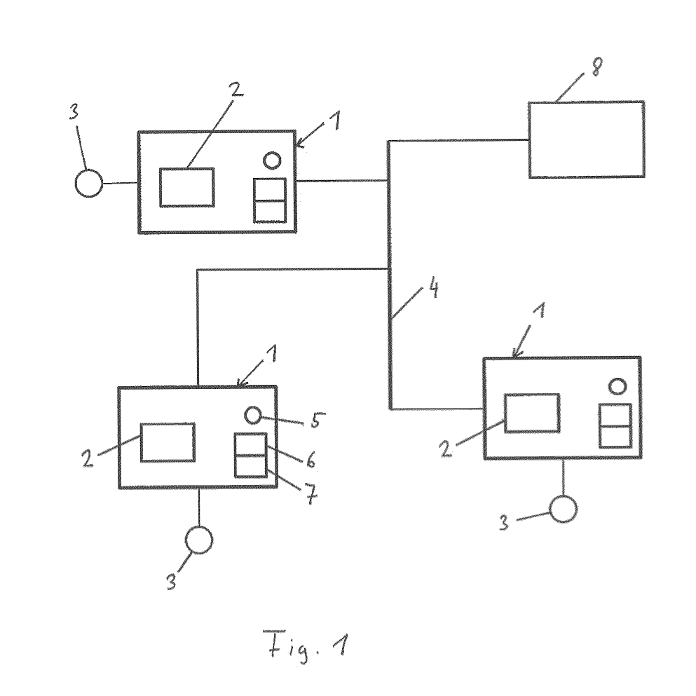

FIG. 1 shows a lighting system having a plurality of components according to the invention in the form of the lamp operating devices.

FIG. 1 shows a lighting system in which a plurality of components according to the invention are arranged. These components according to the invention are lamp operating devices 1 which each control or operate a lamp or luminaire 3. As can be gathered from FIG. 1, a lamp or luminaire 3 is respectively connected to one of the lamp operating devices 1.

In addition, provision is also made for the lamp operating devices 1 to be connected to a central unit 8. This connection can be effected, for example, using a corresponding bus 4. For this purpose, each of the lamp operating devices 1 has corresponding communication means which, like the means needed to operate the lamp 3, are not shown in FIG. 1.

In addition, each of the lamp operating devices also has a computing unit or CPU 5, a software or program memory 6 and a data memory 7 as well as a management unit 2. In this case, the memories 6 and 7 are used to store the software or data, in which case the CPU 5 carries out computation operations according to the stored software or stored data and, as a result, accordingly regulates or controls the lamp operating devices 1 or the lamps 3 connected to the lamp operating devices 1.

The management unit 2 is now provided for the purpose of being able to reconfigure the lamp operating devices 1 even during ongoing operation of the lamp operating devices 1. When reconfiguring a lamp operating device 1, at least part of the software or data stored in the lamp operating device 1 is updated and/or additional software or data is/are stored in the lamp operating device 1 in this case. During updating, that part of the software or data which is not being used by the lamp operating device 1 at the time of the reconfiguration is updated in this case. As a result of this configuration, it is no longer necessary to switch off or deactivate the lamp operating device 1. Accordingly, a reconfiguration can no longer be discerned by a consumer or user and therefore also no longer has a disruptive effect.

Furthermore, provision may be made for the lamp operating devices 1 to be delivered and installed only with particular basic functions which are sufficient at the time of installation. However, it could then be desirable at a subsequent time to be able to add additional functions to individual lamp operating devices 1 without the lamp operating devices 1 having to be deactivated or switched off. The present invention now also makes it possible to store additional software or data in the lamp operating device 1 during ongoing operation. It is therefore possible to expand the functionality of individual lamp operating devices 1 even during ongoing operation.

The software or data provided for updating or expansion may be transmitted, for example, from the central unit 8 in the lighting system to the lamp operating devices 1 and therefore to the management unit 2 via the bus 4. Alternatively, however, provision could also be made for the software or data to be transmitted by a maintenance engineer to the lamp operating devices, for example.

It should be noted with respect to the management units 2 that both the configuration and the state of the lamp operating devices 1 and the software or data stored in the lamp operating devices 1 are known to said management units, as a result of which it is possible for the management unit 2 to readily initiate or carry out the corresponding reconfiguration.

One embodiment variant of the present invention can then provide, for example, for a dimming curve to be stored in the lamp operating device 1 as part of the software or data. After the lamp operating device 1 has been operating for some time, it may then be possibly desirable to store a new dimming curve in the lamp operating device 1.

In this case, the invention then provides for the lamp operating device 1 to still use the old dimming curve while the new dimming curve is being transmitted. The changeover to the new dimming curve is then carried out only after transmission has been concluded. If desired, the old dimming curve can then be released or deleted. Alternatively, a new dimming curve could also be desired in parallel with the old dimming curve in the lamp operating device 1. In this case, the dimming curve is again transmitted to or stored in the lamp operating device 1, in which case the new dimming curve can then be used if desired after transmission has been concluded.

Another embodiment variant may provide for fault diagnosis functions to be updated or additionally stored in a lamp operating device 1. This is important, in particular, when a fault occurs in the lamp operating device 1 or in the connected lamp 3. Depending on the fault, a fault diagnosis function can then be updated or an additional new fault diagnosis function can be transmitted to the lamp operating device 1. This then makes it possible to better diagnose and evaluate the corresponding fault or else to evaluate new types of fault in the first place. In addition, it is also possible for the lamp operating device 1 to then receive a new function which enables increased logging or increased testing or a changeover to a secure algorithm or to an algorithm which consumes less energy.

Another embodiment variant may provide for functions to be transmitted to the lamp operating device 1 by means of the reconfiguration, which functions make it possible to transfer calculation tasks, which should be carried out by one lamp operating device 1 during operation, to another lamp operating device 1 of the lighting system. This distribution of computation tasks makes it possible to optimally use the computing power and computing efficiency of the different lamp operating devices 1. This may also be of interest, for example, if different generations of lamp operating devices 1 are used in a lighting system. In particular, older lamp operating devices 1 have a considerably worse computing power than newer lamp operating devices. Accordingly, in the case of computation-intensive functions, it may be useful to transfer computation tasks from older lamp operating devices to new lamp operating devices.

The distribution of the computation tasks could also be useful when the energy consumption of the entire lighting system should be optimized since different lamp operating device types also have different energy efficiencies depending on the computation task. It is therefore conceivable for a particular computation task to be able to be carried out in a particularly energy-efficient manner in a particular lamp operating device type, whereas another computation task can be carried out in a particularly energy-efficient manner in another lamp operating device type.

The computation tasks can also be distributed, in principle, independently of the reconfiguration of the components, thus being able to increase or optimize the computing power of the entire lighting system and also possibly optimize the energy efficiency.

The lamp operating devices 1 shown in FIG. 1 are only possible examples of components in lighting systems. As already explained at the outset, the components may be many different parts of a lighting system, in which case they are, in particular, components in which software or data can be updated or additionally stored. It would be conceivable, for example, for a controller to also additionally be provided in FIG. 1, which controller is connected to the central unit 8, the lamp operating devices 1 then being connected to this controller. In this case, a reconfiguration would then also be possible in the controller. In addition, the distribution of the computing power is also possibly useful here since, in the case of temporarily increased requirements in the controller for example, it is useful to transfer particular computation tasks or algorithm parts to the lamp operating devices 1 and to have them calculated there and to then report the results back to the controller.

Furthermore, it should also be noted that the embodiment variants mentioned above can also be provided together in any desired combination.

1. A method for reconfiguring components arranged in a lighting system, wherein, when reconfiguring a component, at least part of the software or data stored in the component is updated and/or additional software or data is/are stored in the component, wherein the reconfiguration is carried out during ongoing operation of the component.

2. The method as claimed in claim 1, wherein that part of the software or data which is not being used by the component at the time of the reconfiguration is updated.

3. The method as claimed in claim 1, wherein a component has basic operating functions before the reconfiguration and is expanded with additional functions as a result of the reconfiguration.

4. The method as claimed in claim 1, wherein at least part of the software or data is parameters which are used to control the component or devices connected to the component.

5. The method as claimed in claim 4, wherein the parameters are dimming curves.

6. The method as claimed in claim 4, wherein when updating the parameters, the component still uses the old parameters while new parameters are being transmitted to the component and uses the new parameters after transmission has been concluded.

7. The method as claimed in claim 6, wherein the old parameters are deleted after transmission has been concluded.

8. The method as claimed in claim 4, wherein when storing additional parameters, the component uses the additional parameters after the transmission of the additional parameters has been concluded.

9. The method as claimed in claim 1, wherein at least part of the software or data is fault diagnosis functions which diagnose and evaluate faults in the component or in devices connected to the component.

10. The method as claimed in claim 9, wherein the fault diagnosis functions are updated and/or additional fault diagnosis functions are stored when a fault occurs.

11. The method as claimed in claim 1, wherein at least part of the software or data is functions which make it possible to transfer calculation tasks, which should be carried out by one component during operation, to another component of the lighting system.

12. The method as claimed in claim 11, wherein the energy efficiency, the computing time and/or the resources of the components or of the lighting system are optimized by transferring calculation tasks.

13. A component of a lighting system, having a management unit which makes it possible to update at least part of the software or data stored in the component and/or to store additional software or data in the component during ongoing operation of the component.

14. The component as claimed in claim 13, wherein the configuration and state of the component and the software or data stored in the component are known to the management unit.

15. A method for dividing computation tasks between a plurality of components of a lighting system, in which the components have functions which make it possible to transfer calculation tasks, which should be carried out by one component during operation, to another component of the lighting system.

16. The method as claimed in claim 15, wherein the energy efficiency, the computing time and/or the resources of the components or of the lighting system are optimized by transferring calculation tasks.

17. The method as claimed in claim 1, wherein at least some of the components are lamp operating devices.

18. The method as claimed in claim 1, wherein at least some of the components are controllers which are provided for the purpose of controlling a plurality of luminaires or lamp operating devices.

19. The component as claimed in claim 13, wherein at least some of the components are lamp operating devices.

20. The component as claimed in claim 13, wherein at least some of the components are controllers which are provided for the purpose of controlling a plurality of luminaires or lamp operating devices.
